(19) United States
(12) Patent Application Publication
(10) Pub. No.: US 2005/0182915 A1
(43) Pub. Date: Aug. 18, 2005

(54) Chip multiprocessor for media applications

(76) Inventors: Patrick Devaney, Haverhill, MA (US); David M. Keaton, Boulder, CO (US); Katsumi Murai, Osaka (JP)

Correspondence Address: RATNERPRESTIA, P O BOX 980, VALLEY FORGE, PA, 19482-0980, US

(21) Appl. No.: 10/777,934

(22) Filed: Feb. 12, 2004

(51) Int. Cl. G06F 15/00

(52) U.S. Cl. 712/10

(57) ABSTRACT

A chip multiprocessor (CMP) includes a plurality of processors disposed on a peripheral region of a chip. Each processor has (a) a dual datapath for executing instructions, (b) a compiler controlled register file (RF), coupled to the dual datapath, for loading/storing operands of an instruction, and (c) a compiler controlled local memory (LM), a portion of the LM disposed to a left of the dual datapath and another portion of the LM disposed to a right of the dual datapath, for loading/storing operands of an instruction. The CMP also has a shared main memory disposed at a central region of the chip, a crossbar system for coupling the shared main memory to each of the processors, and a first-in-first-out (FIFO) system for transferring operands of an instruction among multiple processors.

### TECHNICAL FIELD

The present invention relates, in general, to data processing systems and, more specifically, to a homogeneous chip multiprocessor (CMP) built from clusters of multiple central processing units (CPUs).

### BACKGROUND OF THE INVENTION

Advances in semiconductor technology have created reasonably-priced chips with literally hundreds of millions of transistors. This transistor budget has revealed the lack of scalability of both multi-issue uni-processor architectures, such as instruction level parallelism (ILP) (superscalar and VLIW), and of the classic vector architecture. The most common use for the increased transistor budget in CPU designs has been to increase the amount of on-chip cache. The performance increase in such CPUs, however, soon reached the point of diminishing returns.

As semiconductor design rules shrank, some scaling problems began to appear. Wire delays have failed to scale. This issue has been postponed for about one silicon process generation by moving to copper interconnects and low-k dielectrics. But CPU designers already know they should no longer expect a signal to propagate completely across a standard-sized die within a single clock tic. Such scaling problems are driving CPU designers to multi-processors.

Another factor driving the partitioning of the single, monolithic CPU is bypass logic. As CPU architects add more stages to their pipelines to increase speed and more instruction issues to their ILP architectures to increase instructions-per-clock, the bypass logic that routes partial results back to earlier stages in the pipeline undergoes a combinatoric explosion, which indicates that the number of pipeline stages has some optimum at a modest number of stages.

Perhaps, the dominant factor driving partitioning is the number of register ports. Each ILP issue instruction adds three ports (source 1, source 2 and destination operands) to the register file. It also requires a larger register file, due to the register pressure of a larger number of partial results that must be kept in registers. Designers have had to partition the register file to reduce the number of ports and, thereby, restore the clock cycle time and chip area to competitive values. But partitioning has added overheads of transfer instructions between register files and has created more difficult scheduling problems. This resulted in the introduction of multiple issue stages (e.g., multi-threading) and multiple register files. Wide ILP hardware (i.e., VLIW) has also been divided into separate CPUs, or multiprocessors.

Architectures that include multiple processors on a single chip are known as chip multiprocessors (CMPs). Multiple copies of identical stand-alone CPUs are placed on a single chip, and fast, fine-grained communication mechanism (such as scheduled writes to remote register files) may be used to combine CPUs to match the intrinsic parallelism of the application. Without fast communications, however, the CMP can only execute coarse-grained multiple-instruction-multiple data (MIMD) calculations.

In general, CPUs in a CMP tend to avoid including hardware that is infrequently used, because in a homogeneous CMP the overhead of the hardware is replicated in each CPU. In addition, CMPs tend to reuse mature and proven CPU designs, such as MIPS. Such reuse allows the design effort to focus on the CMP macro-architecture and provides a legacy code base and programming talent, so that a new software environment need not be developed. This invention addresses such a CMP.

### SUMMARY OF THE INVENTION

To meet this and other needs, and in view of its purposes, the present invention provides a chip multiprocessor (CMP) including a plurality of processors disposed on a peripheral region of a chip. Each processor includes (a) a dual datapath for executing instructions, (b) a compiler controlled register file (RF), coupled to the dual datapath, for holding operands of an instruction, and (c) a compiler controlled local memory (LM), a portion of the LM disposed to a left of the dual datapath and another portion of the LM disposed to a right of the dual datapath, for holding operands of an instruction. The CMP also includes a shared main memory, which uses DRAM, disposed at a central region of the chip, a crossbar system for coupling the shared main memory to each of the processors, and a first-in-first-out (FIFO) system for transferring operands of an instruction among multiple processors of the plurality of processors. In order that the predominantly analog technology of DRAM memory and the digital technology of the processors are able to co-exist on the same chip, an “embedded DRAM” silicon process technology is employed by the invention.

In another embodiment, the invention provides a chip multiprocessor (CMP) including first, second, third and fourth clusters of processors disposed on a peripheral region of a chip, each of the clusters of processors disposed at a different quadrant of the peripheral region of the chip, and each including a plurality of processors for executing instructions. The CMP also includes first, second, third and fourth clusters of embedded DRAM disposed in a central region of the chip, each of the clusters of embedded DRAM disposed at a different quadrant of the central region of the chip. In addition, first, second, third and fourth crossbars, respectively, are disposed above the clusters of embedded DRAM for coupling a respective cluster of processors to a respective cluster of embedded DRAM, wherein a memory load/store instruction is executed by at least one processor in the clusters of processors by accessing at least one of the first, second, third and fourth clusters of embedded DRAM by way of at least one of the first, second, third and fourth crossbars.

It is understood that the foregoing general description and the following detailed description are exemplary, but are not restrictive, of the invention.

### BRIEF DESCRIPTION OF THE DRAWING

The invention is best understood from the following detailed description when read in connection with the accompanying drawing. Included in the drawing are the following figures:

FIG. 1 is a block diagram of a central processing unit (CPU), showing a left data path processor and a right data path processor incorporating an embodiment of the invention;

FIG. 2 is a block diagram of the CPU of FIG. 1 showing in detail the left data path processor and the right data path processor, each processor communicating with a register file, a local memory, a first-in-first-out (FIFO) system and a main memory, in accordance with an embodiment of the invention;

FIG. 3 is a block diagram of a multiprocessor system including multiple CPUs of FIG. 1 showing a processor core (left and right data path processors) communicating with left and right external local memories, a main memory and a FIFO system, in accordance with an embodiment of the invention;

FIG. 4 is a block diagram of a multiprocessor system showing a level-one local memory including pages being shared by a left CPU and a right CPU, in accordance with an embodiment of the invention;

FIG. 5 is a block diagram of a multiprocessor system showing local memory banks, in which each memory bank is disposed physically between a CPU to its left and a CPU to its right, in accordance with an embodiment of the invention;

FIG. 6 is a diagram of a homogeneous core of a CMP on a single chip, illustrating the physical orientations of multiple processors in multiple clusters, and their relationship to multiple embedded DRAM plus crossbars, in accordance with an embodiment of the invention;

FIG. 7 is a diagram of multiple processors of a cluster coupled to embedded DRAM pages by way of a crossbar, in accordance with an embodiment of the invention;

FIG. 8 is a diagram of multiple clusters interconnected by multiple crossbars including inter-bus arbitrators between the crossbars, in accordance with an embodiment of the invention;

FIG. 9 is an example of a bitfield for specifying an address of a location in the embedded DRAM pages disposed in different quadrants of the CMP illustrated in FIG. 6, in accordance with an embodiment of the invention;

FIG. 10 is another example of a bitfield for specifying an address of a location in the embedded DRAM pages disposed in different quadrants of the CMP illustrated in FIG. 6 including additional bitfields for controlling the split-transactions implemented on the busses of the crossbars, in accordance with an embodiment of the invention;

FIGS. 11a and 11b are examples of bit values used in the bitfields, respectively, shown in FIGS. 9 and 10, in accordance with an embodiment of the invention;

FIG. 12 is an example used to explain the manner in which a CPU, residing in cluster 0, reads from and writes data to a DRAM page, residing in cluster 3 of the CMP illustrated in FIG. 6, in accordance with an embodiment of the invention; and

FIG. 13 is an example of a FIFO system used for communication amongst four CPUs belonging in cluster 1 of the CMP shown in FIG. 6, specifically illustrating FIFOs mapped to the internal register file of CPU 6, in accordance with an embodiment of the invention.

### DETAILED DESCRIPTION OF THE INVENTION

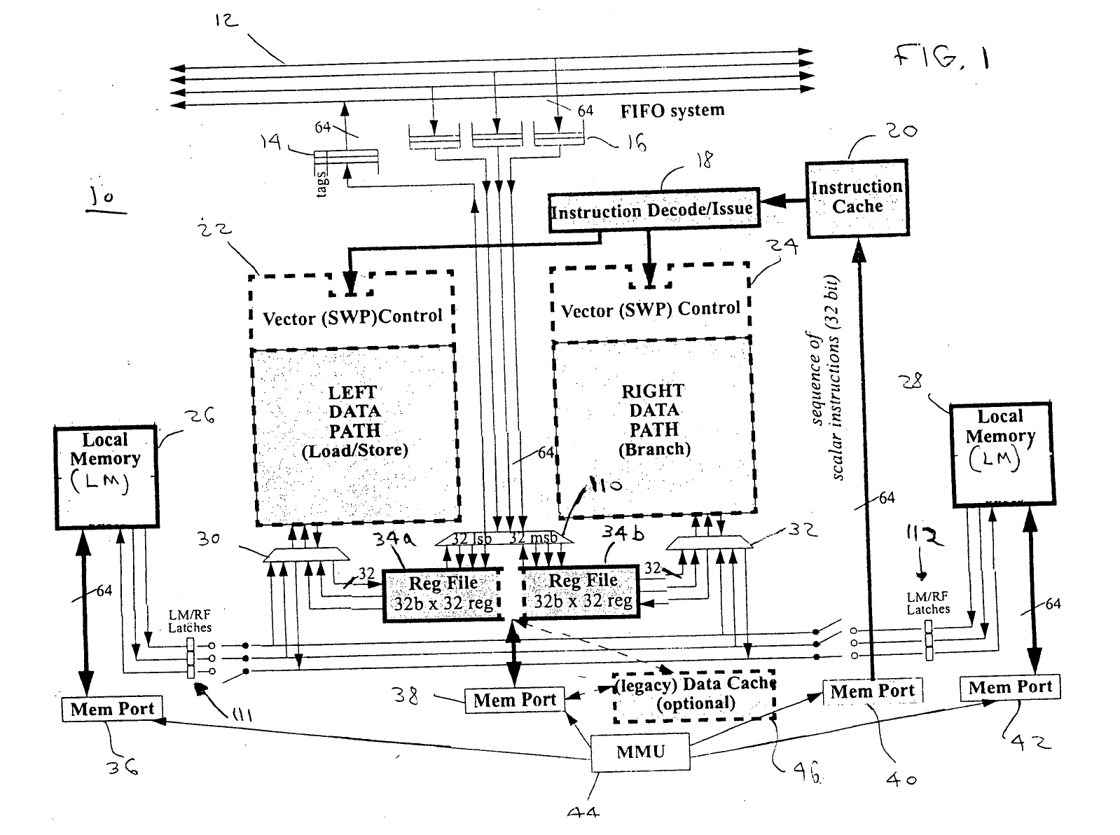

Referring to FIG. 1, there is shown a block diagram of a central processing unit (CPU), generally designated as 10. CPU 10 is a two-issue-super-scalar (2i-SS) instruction processor-core capable of executing multiple scalar instructions simultaneously or executing one vector instruction. A left data path processor, generally designated as 22, and a right data path processor, generally designated as 24, receive scalar or vector instructions from instruction decoder 18.

Instruction cache 20 stores read-out instructions, received from memory port 40 (accessing main memory), and provides them to instruction decoder 18. The instructions are decoded by decoder 18, which generates signals for the execution of each instruction, for example signals for controlling sub-word parallelism (SWP) within processors 22 and 24 and signals for transferring the contents of fields of the instruction to other circuits within these processors.

CPU 10 includes an internal register file which, when executing multiple scalar instructions, is treated as two separate register files 34a and 34b, each containing 32 registers, each having 32 bits. This internal register file, when executing a vector instruction, is treated as 32 registers, each having 64 bits. Register file 34 has four 32-bit read and two write (4R/2W) ports. Physically, the register file is 64 bits wide, but it is split into two 32-bit files when processing scalar instructions.

When processing multiple scalar instructions, two 32-bit wide instructions may be issued in each clock cycle. Two 32-bit wide data may be read from register file 32 from left data path processor 22 and right data path processor 24, by way of multiplexers 30 and 32. Conversely, 32-bit wide data may be written to register file 32 from left data path processor 22 and right data path processor 24, by way of multiplexers 30 and 32. When processing one vector instruction, the left and right 32 bit register files and read/write ports are joined together to create a single 64-bit register file that has two 64-bit read ports and one write port (2R/1W).

CPU 10 includes a level-one local memory (LM) that is externally located of the core-processor and is split into two halves, namely left LM 26 and right LM 28. There is one clock latency to move data between processors 22, 24 and left and right LMs 26, 28. Like register file 34, LM 26 and 28 are each physically 64 bits wide.

It will be appreciated that in the 2i-SS programming model, as implemented in the Sparc architecture, two 32-bit wide instructions are consumed per clock. It may read and write to the local memory with a latency of one clock, which is done via load and store instructions, with the LM given an address in high memory. The 2i-SS model may also issue pre-fetching loads to the LM. The SPARC ISA has no instructions or operands for LM. Accordingly, the LM is treated as memory, and accessed by load and store instructions. When vector instructions are issued, on the other hand, their operands may come from either the LM or the register file (RF). Thus, up to two 64-bit data may be read from the register file, using both multiplexers (30 and 32) working in a coordinated manner. Moreover, one 64 bit datum may also be written back to the register file. One superscalar instruction to one datapath may move a maximum of 32 bits of data, either from the LM to the RF (a load instruction) or from the RF to the LM (a store instruction).

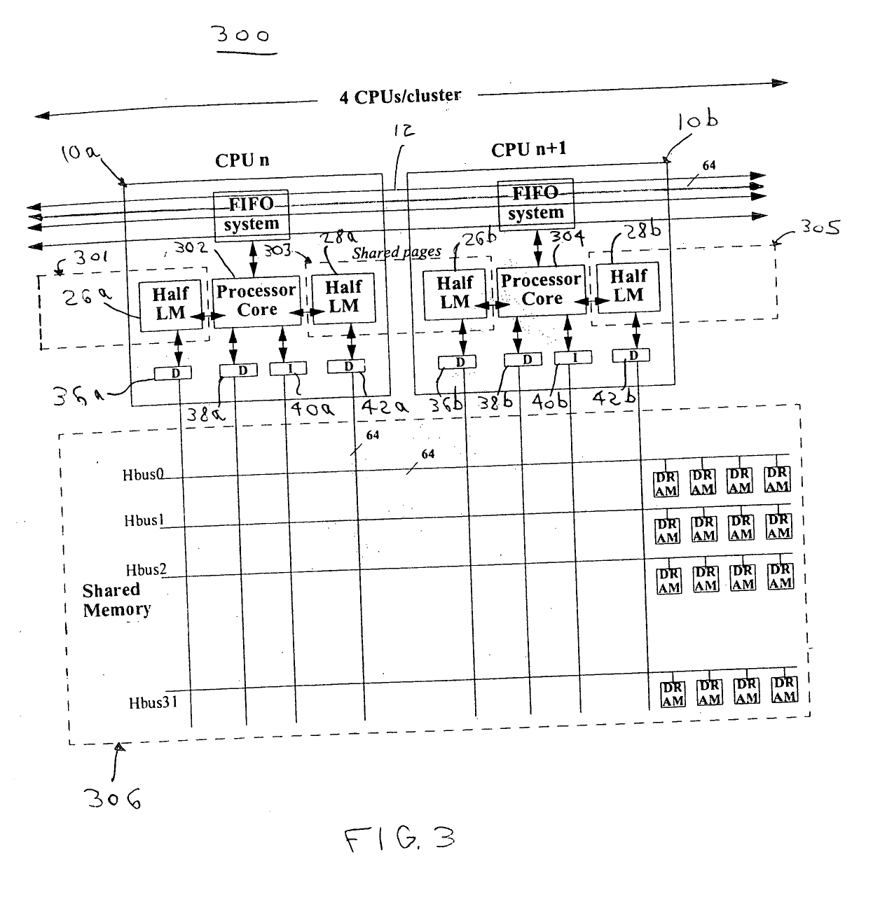

Four memory ports for accessing a level-two main memory of dynamic random access memory (DRAM) (as shown in FIG. 3) are included in CPU 10. Memory port 36 provides 64-bit data to or from left LM 26. Memory port 38 provides 64-bit data to or from register file 34, and memory port 42 provides data to or from right LM 28. 64-bit instruction data is provided to instruction cache 20 by way of memory port 40. Memory management unit (MMU) 44 controls loading and storing of data between each memory port and the DRAM. An optional level-one data cache, such as SPARC legacy data cache 46, may be accessed by CPU 10. In case of a cache miss, this cache is updated by way of memory port 38 which makes use of MMU 44.

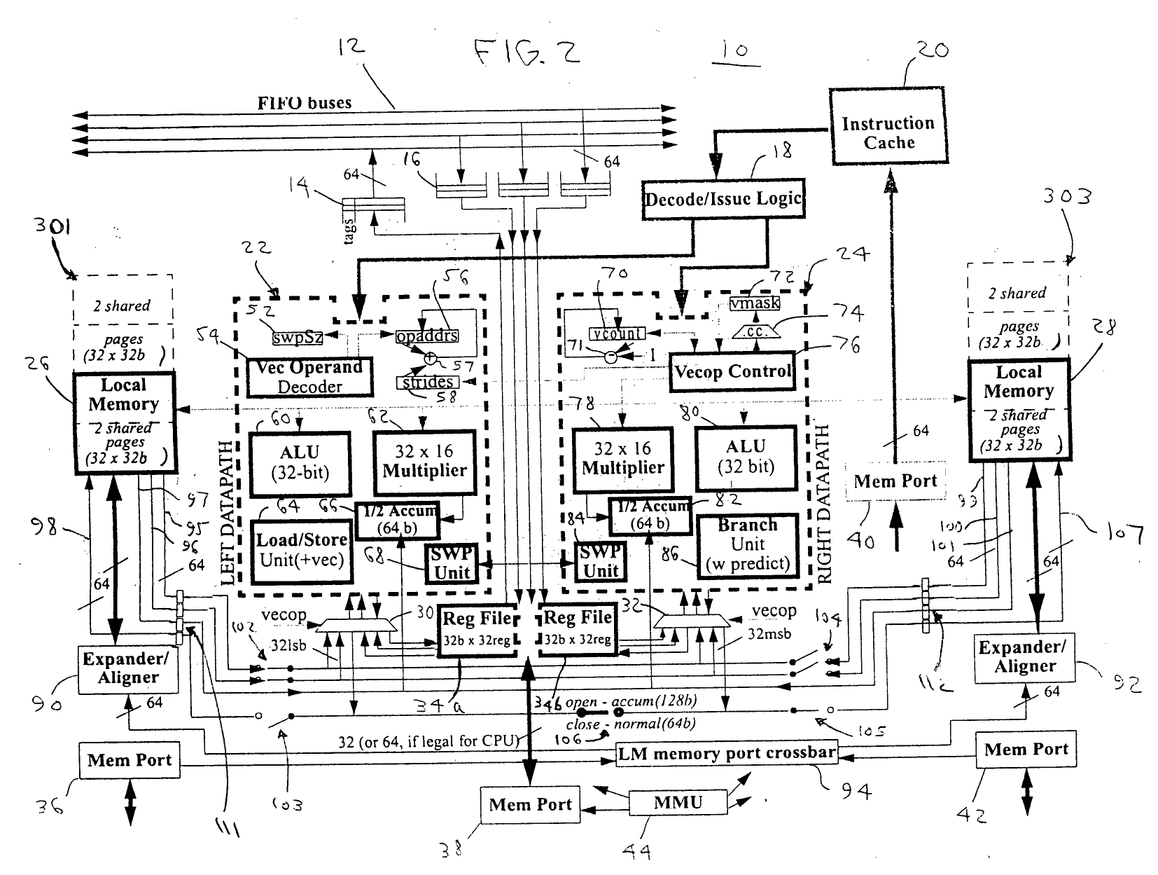

CPU 10 may issue two kinds of instructions: scalar and vector. Using instruction level parallelism (ILP), two independent scalar instructions may be issued to left data path processor 22 and right data path processor 24 by way of memory port 40. In scalar instructions, operands may be delivered from register file 34 and load/store instructions may move 32-bit data from/to the two LMs. In vector instructions, combinations of two separate instructions define a single vector instruction, which may be issued to both data paths under control of a vector control unit (as shown in FIG. 2). In vector instruction, operands may be delivered from the LMs and/or register file 34. Each scalar instruction processes 32 bits of data, whereas each vector instruction may process N×64 bits (where N is the vector length).

CPU 10 includes a first-in first-out (FIFO) buffer system having output buffer FIFO 14 and three input buffer FIFOs 16. The FIFO buffer system couples CPU 10 to neighboring CPUs (as shown in FIG. 3) of a multiprocessor system by way of multiple busses 12. The FIFO buffer system may be used to chain consecutive vector operands in a pipeline manner. The FIFO buffer system may transfer 32-bit or 64-bit instructions/operands from CPU 10 to its neighboring CPUs. The 32-bit or 64-bit data may be transferred by way of bus splitter 110.

Referring next to FIG. 2, CPU 10 is shown in greater detail. Left data path processor 22 includes arithmetic logic unit (ALU) 60, half multiplier 62, half accumulator 66 and sub-word processing (SWP) unit 68. Similarly, right data path processor 24 includes ALU 80, half multiplier 78, half accumulator 82 and SWP unit 84. ALU 60, 80 may each operate on 32 bits of data and half multiplier 62, 78 may each multiply 32 bits by 16 bits, or 2×16 bits by 16 bits. Half accumulator 66, 82 may each accumulate 64 bits of data and SWP unit 68, 84 may each process 8 bit, 16 bit or 32 bit quantities.

Non-symmetrical features in left and right data path processors include load/store unit 64 in left data path processor 22 and branch unit 86 in right data path processor 24. With a two-issue super scalar instruction, for example, provided from instruction decoder 18, the left data path processor includes instruction to the load/store unit for controlling read/write operations from/to memory, and the right data path processor includes instructions to the branch unit for branching with prediction. Accordingly, load/store instructions may be provided only to the left data path processor, and branch instructions may be provided only to the right data path processor.

For vector instructions, some processing activities are controlled in the left data path processor and some other processing activities are controlled in the right data path processor. As shown, left data path processor 22 includes vector operand decoder 54 for decoding source and destination addresses and storing the next memory addresses in operand address buffer 56. The current addresses in operand address buffer 56 are incremented by strides adder 57, which adds stride values stored in strides buffer 58 to the current addresses stored in operand address buffer 56.

It will be appreciated that vector data include vector elements stored in local memory at a predetermined address interval. This address interval is called a stride. Generally, there are various strides of vector data. If the stride of vector data is assumed to be “1”, then vector data elements are stored at consecutive storage addresses. If the stride is assumed to be “8”, then vector data elements are stored 8 locations apart (e.g. walking down a column of memory registers, instead of walking across a row of memory registers). The stride of vector data may take on other values, such as 2 or 4.

Vector operand decoder 54 also determines how to treat the 64 bits of data loaded from memory. The data may be treated as two-32 bit quantities, four-16 bit quantities or eight-8 bit quantities. The size of the data is stored in sub-word parallel size (SWPSZ) buffer 52.

The right data path processor includes vector operation (vecop) controller 76 for controlling each vector instruction. A condition code (CC) for each individual element of a vector is stored in cc buffer 74. A CC may include an overflow condition or a negative number condition, for example. The result of the CC may be placed in vector mask (Vmask) buffer 72.

It will be appreciated that vector processing reduces the frequency of branch instructions, since vector instructions themselves specify repetition of processing operations on different vector elements. For example, a single instruction may be processed up to 64 times (e.g. loop size of 64). The loop size of a vector instruction is stored in vector count (Vcount) buffer 70 and is automatically decremented by “1” via subtractor 71. Accordingly, one instruction may cause up to 64 individual vector element calculations and, when the Vcount buffer reaches a value of “0”, the vector instruction is completed. Each individual vector element calculation has its own CC.

It will also be appreciated that because of sub-word parallelism capability of CPU 10, as provided by SWPSZ buffer 52, one single vector instruction may process in parallel up to 8 sub-word data items of a 64 bit data item. Because the mask register contains only 64 entries, the maximum size of the vector is forced to create no more SWP elements than the 64 which may be handled by the mask register. It is possible to process, for example, up to 8×64 elements if the operation is not a CC operation, but then there may be potential for software-induced error. As a result, the invention limits the hardware to prevent such potential error.

Turning next to the internal register file and the external local memories, left data path processor 22 may load/store data from/to register file 34a and right data path processor 24 may load/store data from/to register file 34b, by way of multiplexers 30 and 32, respectively. Data may also be loaded/stored by each data path processor from/to LM 26 and LM 28, by way of multiplexers 30 and 32, respectively. During a vector instruction, two-64 bit source data may be loaded from LM 26 by way of busses 95, 96, when two source switches 102 are closed and two source switches 104 are opened. Each 64 bit source data may have its 32 least significant bits (LSB) loaded into left data path processor 22 and its 32 most significant bits (MSB) loaded into right data path processor 24. Similarly, two-64 bit source data may be loaded from LM 28 by way of busses 99, 100, when two source switches 104 are closed and two source switches 102 are opened.

Separate 64 bit source data may be loaded from LM 26 by way of bus 97 into half accumulators 66, 82 and, simultaneously, separate 64 bit source data may be loaded from LM 28 by way of bus 101 into half accumulators 66, 82. This provides the ability to preload a total of 128 bits into the two half accumulators.

Separate 64-bit destination data may be stored in LM 28 by way of bus 107, when destination switch 105 and normal/accumulate switch 106 are both closed and destination switch 103 is opened. The 32 LSB may be provided by left data path processor 22 and the 32 MSB may be provided by right data path processor 24. Similarly, separate 64-bit destination data may be stored in LM 26 by way of bus 98, when destination switch 103 and normal/accumulate switch 106 are both closed and destination switch 105 is opened. The load/store data from/to the LMs are buffered in left latches 111 and right latches 112, so that loading and storing may be performed in one clock cycle.

If normal/accumulate switch 106 is opened and destination switches 103 and 105 are both closed, 128 bits may be simultaneously written out from half accumulators 66, 82 in one clock cycle. 64 bits are written to LM 26 and the other 64 bits are simultaneously written to LM 28.

LM 26 may read/write 64 bit data from/to DRAM by way of LM memory port crossbar 94, which is coupled to memory port 36 and memory port 42. Similarly, LM 28 may read/write 64 bit data from/to DRAM. Register file 34 may access DRAM by way of memory port 38 and instruction cache 20 may access DRAM by way of memory port 40. MMU 44 controls memory ports 36, 38, 40 and 42.

Disposed between LM 26 and the DRAM is expander/aligner 90 and disposed between LM 28 and the DRAM is expander/aligner 92. Each expander/aligner may expand (duplicate) a word from DRAM and write it into an LM. For example, a word at address 3 of the DRAM may be duplicated and stored in LM addresses 0 and 1. In addition, each expander/aligner may take a word from the DRAM and properly align it in a LM. For example, the DRAM may deliver 64 bit items which are aligned to 64 bit boundaries. If a 32 bit item is desired to be delivered to the LM, the expander/aligner automatically aligns the delivered 32 bit item to 32 bit boundaries.

External LM 26 and LM 28 will now be described by referring to FIGS. 2 and 3. Each LM is physically disposed externally of and in between two CPUs in a multiprocessor system. As shown in FIG. 3, multiprocessor system 300 includes 4 CPUs per cluster (only two CPUs shown). CPUn is designated 10a and CPUn+1 is designated 10b. CPUn includes processor-core 302 and CPUn+1 includes processor-core 304. It will be appreciated that each processor-core includes a left data path processor (such as left data path processor 22) and a right data path processor (such as right data path processor 24).

A whole LM is disposed between two CPUs. For example, whole LM 301 is disposed between CPUn and CPUn-1 (not shown), whole LM 303 is disposed between CPUn and CPUn+1, and whole LM 305 is disposed between CPUn+1 and CPUn+2 (not shown). Each whole LM includes two half LMs. For example, whole LM 303 includes half LM 28a and half LM 26b. By partitioning the LMs in this manner, processor core 302 may load/store data from/to half LM 26a and half LM 28a. Similarly, processor core 304 may load/store data from/to half LM 26b and half LM 28b.

As shown in FIG. 2, whole LM 301 includes 4 pages, with each page having 32×32 bit registers. Processor core 302 (FIG. 3) may typically access half LM 26a on the left side of the core and half LM 28a on the right side of the core. Each half LM includes 2 pages. In this manner, processor core 302 and processor core 304 may each access a total of 4 pages of LM.

It will be appreciated, however, that if processor core 302 (for example) requires more than 4 pages of LM to execute a task, the operating system may assign to processor core 302 up to 4 pages of whole LM 301 on the left side and up to 4 pages of whole LM 303 on the right side. In this manner, CPUn may be assigned 8 pages of LM to execute a task, should the task so require.

Completing the description of FIG. 3, busses 12 of each FIFO system of CPUn and CPUn+1 corresponds to busses 12 shown in FIG. 2. Memory ports 36a, 38a, 40a and 42a of CPUn and memory ports 36b, 38b, 40b and 42b of CPUn+1 correspond, respectively, to memory ports 36, 38, 40 and 42 shown in FIG. 2. Each of these memory ports may access level-two memory 306 including a large crossbar, which may have, for example, 32 busses interfacing with a DRAM memory area. A DRAM page may be, for example, 32 K Bytes and there may be, for example, up to 128 pages per 4 CPUs in multiprocessor 300. The DRAM may include buffers plus sense-amplifiers to allow a next fetch operation to overlap a current read operation.

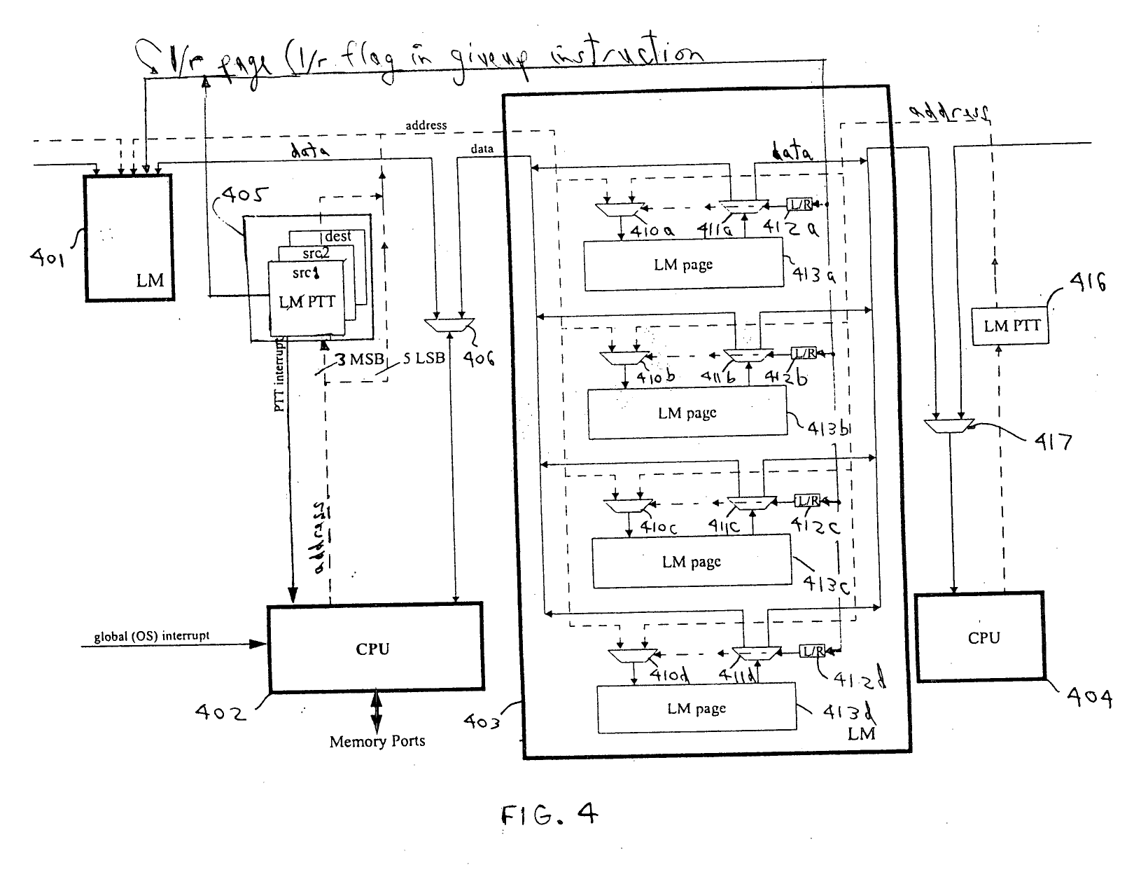

Referring next to FIG. 4, there is shown multiprocessor system 400 including CPU 402 accessing LM 401 and LM 403. It will be appreciated that LM 403 may be cooperatively shared by CPU 402 and CPU 404. Similarly, LM 401 may be shared by CPU 402 and another CPU (not shown). In a similar manner, CPU 404 may access LM 403 on its left side and another LM (not shown) on its right side.

LM 403 includes pages 413a, 413b, 413c and 413d. Page 413a may be accessed by CPU 402 and CPU 404 via address multiplexer 410a, based on left/right (L/R) flag 412a issued by LM page translation table (PTT) control logic 405. Data from page 413a may be output via data multiplexer 411a, also controlled by L/R flag 412a. Page 413b may be accessed by CPU 402 and CPU 404 via address multiplexer 410b, based on left/right (L/R) flag 412b issued by the PTT control logic. Data from page 413b may be output via data multiplexer 411b, also controlled by L/R flag 412b. Similarly, page 413c may be accessed by CPU 402 and CPU 404 via address multiplexer 410c, based on left/right (L/R) flag 412c issued by the PTT control logic. Data from page 413c may be output via data multiplexer 411c, also controlled by L/R flag 412c. Finally, page 413d may be accessed by CPU 402 and CPU 404 via address multiplexer 410d, based on left/right (L/R) flag 412d issued by the PTT control logic. Data from page 413d may be output via data multiplexer 411d, also controlled by L/R flag 412d. Although not shown, it will be appreciated that the LM control logic may issue four additional L/R flags to LM 401.

CPU 402 may receive data from a register in LM 403 or a register in LM 401 by way of data multiplexer 406. As shown, LM 403 may include, for example, 4 pages, where each page may include 32×32 bit registers (for example). CPU 402 may access the data by way of an 8-bit address line, for example, in which the 5 least significant bits (LSB) bypass LM PTT control logic 405 and the 3 most significant bits (MSB) are sent to the LM PTT control logic.

It will be appreciated that CPU 404 includes LM PTT control logic 416 which is similar to LM PTT control logic 405, and data multiplexer 417 which is similar to data multiplexer 406. Furthermore, as will be explained, each LM PTT control logic includes three identical PTTs, so that each CPU may simultaneously access two source operands (SRC1, SRC2) and one destination operand (dest) in the two LMs (one on the left and one on the right of the CPU) with a single instruction.

Moreover, the PTTs make the LM page numbers virtual, thereby simplifying the task of the compiler and the OS in finding suitable LM pages to assign to potentially multiple tasks assigned to a single CPU. As the OS assigns tasks to the various CPUs, the OS also assigns to each CPU only the amount of LM pages needed for a task. To simplify control of this assignment, the LM is divided into pages, each page containing 32×32 bit registers.

An LM page may only be owned by one CPU at a time (by controlling the setting of the L/R flag from the PTT control logic), but the pages do not behave like a conventional shared memory. In the conventional shared memory, the memory is a global resource, and processors compete for access to it. In this invention, however, the LM is architected directly into both processors (CPUs) and both are capable of owning the LM at different times. By making all LM registers architecturally visible to both processors (one on the left and one on the right), the compiler is presented with a physically unchanging target, instead of a machine whose local memory size varies from task to task.

A compiled binary may require an amount of LM. It assumes that enough LM pages have been assigned to the application to satisfy the binary's requirements, and that those pages start at page zero and are contiguous. These assumptions allow the compiler to produce a binary whose only constraint is that a sufficient number of pages are made available; the location of these pages does not matter. In actuality, however, the pages available to a given CPU depend upon which pages have already been assigned to the left and right neighbors CPUs. In order to abstract away which pages are available, the page translation table is implemented by the invention (i.e., the LM page numbers are virtual.)

An abstract of a LM PTT is shown below.

| Logical | | Physical |
|---|---|---|
| Page | Valid? | Page |
| 0 | Y | 0 |
| 1 | Y | 5 |
| 2 | N | (6) |
| 3 | Y | 4 |

As shown in the table, each entry has a protection bit, namely a valid (or accessible)/not valid (or not accessible) bit. If the bit is set, the translation is valid (page is accessible); otherwise, a fatal error is generated (i.e., a task is erroneously attempting to write to an LM page not assigned to that task). The protection bits are set by the OS at task start time. Only the OS may set the protection bits.

In addition to the protection bits (valid/not valid) (accessible/not accessible) provided in each LM PTT, each physical page of a LM has an owner flag associated with it, indicating whether its current owner is the CPU to its right or to its left. The initial owner flag is set by the OS at task start time. If neither neighbor CPU has a valid translation for a physical page, that page may not be accessed; so the value of its owner bit is moot. If a valid request to access a page comes from a CPU, and the requesting CPU is the current owner, the access proceeds. If the request is valid, but the CPU is not the current owner, then the requesting CPU stalls until the current owner issues a giveup page command for that page. Giveup commands, which may be issued by a user program, toggle the ownership of a page to the opposite processor. Giveup commands are used by the present invention for changing page ownership during a task. Attempting to giveup an invalid (or not accessible) (protected) page is a fatal error.

When a page may be owned by both adjacent processors, it is used cooperatively, not competitively by the invention. There is no arbitration for control. Cooperative ownership of the invention advantageously facilitates double-buffered page transfers and pipelining (but not chaining) of vector registers, and minimizes the amount of explicit signaling. It will be appreciated that, unlike the present invention, conventional multiprocessing systems incorporate writes to remote register files. But, remote writes do not reconfigure the conventional processor's architecture; they merely provide a communications pathway, or a mailbox. The present invention is different from mailbox communications.

At task end time, all pages and all CPUs, used by the task, are returned to the pool of available resources. For two separate tasks to share a page of a LM, the OS must make the initial connection. The OS starts the first task, and makes a page valid (accessible) and owned by the first CPU. Later, the OS starts the second task and makes the same page valid (accessible) to the second CPU. In order to do this, the two tasks have to communicate their need to share a page to the OS. To prevent premature inter-task giveups, it may be necessary for the first task to receive a signal from the OS indicating that the second task has started.

In an exemplary embodiment, a LM PTT entry includes a physical page location (1 page out of possible 8 pages) corresponding to a logical page location, and a corresponding valid/not valid protection bit (Y/N), both provided by the OS. Bits of the LM PTT, for example, may be physically stored in ancillary state registers (ASR's) which the Scalable Processor Architecture (SPARC) allows to be implementation dependent. SPARC is a CPU instruction set architecture (ISA), derived from a reduced instruction set computer (RISC) lineage. SPARC provides special instructions to read and write ASRs, namely rdasr and wrasr.

According to the an embodiment of the architecture, if the physical register is implemented to be only accessible by a privileged user, then a rd/wrasr instruction for that register also requires a privileged user. Therefore, in this embodiment, the PTTs are implemented as privileged write-only registers (write-only from the point of view of the OS). Once written, however, these registers may be read by the LM PTT control logic whenever a reference is made to a LM page by an executing instruction.

The LM PTT may be physically implemented in one of the privileged ASR registers (ASR 8, for example) and written to only by the OS. Once written, a CPU may access a LM via the three read ports of the LM register.

It will be appreciated that the LM PTT of the invention is similar to a page descriptor cache or a translation lookaside buffer (TLB). A conventional TLB, however, has a potential to miss (i.e., an event in which a legal virtual page address is not currently resident in the TLB). In a miss circumstance, the TLB must halt the CPU (by a page fault interrupt), run an expensive miss processing routine that looks up the missing page address in global memory, and then write the missing page address into the TLB. The LM PTT of the invention, on the other hand, only has a small number of pages (e.g. 8) and, therefore, advantageously all pages may reside in the PTT. After the OS loads the PTT, it is highly unlikely for a task not to find a legal page translation. The invention, thus, has no need for expensive miss processing hardware, which is often built into the TLB.

Furthermore, the left/right task owners of a single LM page are similar to multiple contexts in virtual memory. Each LM physical page has a maximum of two legal translations: to the virtual page of its left-hand CPU or to the virtual page of its right hand CPU. Each translation may be stored in the respective PTT. Once again, all possible contexts may be kept in the PTT, so multiple contexts (more than one task accessing the same page) cannot overflow the size of the PTT.

Four flags out of a possible eight flags are shown in FIG. 4 as L/R flags 412a-d controlling multiplexers 410a-d and 411a-d, respectively. As shown, CPU 402, 404 (for example) initially sets 8 bits (corresponding to 8 pages per CPU) denoting L/R ownership of LM pages. The L/R flags may be written into a non-privileged register. It will be appreciated that in the SPARC ISA a non-privileged register may be, for example ASR 9.

In operation, the OS handler reads the new L/R flags and sets them in a non privileged register. A task which currently owns a LM page may issue a giveup command. The giveup command specifies which page's ownership is to be transferred, so that the L/R flag may be toggled (for example, L/R flag 412a-d).

As shown, the page number of the giveup is passed through srcl in LM PTT control logic 405 which, in turn, outputs a physical page. The physical page causes a 1 of 8 decoder to write the page ownership (coming from the CPU as an operand of the giveup instruction) to the bit of a non-privileged register corresponding to the decoded physical page. There is no OS intervention for the page transfer. This makes the transfer very fast, without system calls or arbitration.

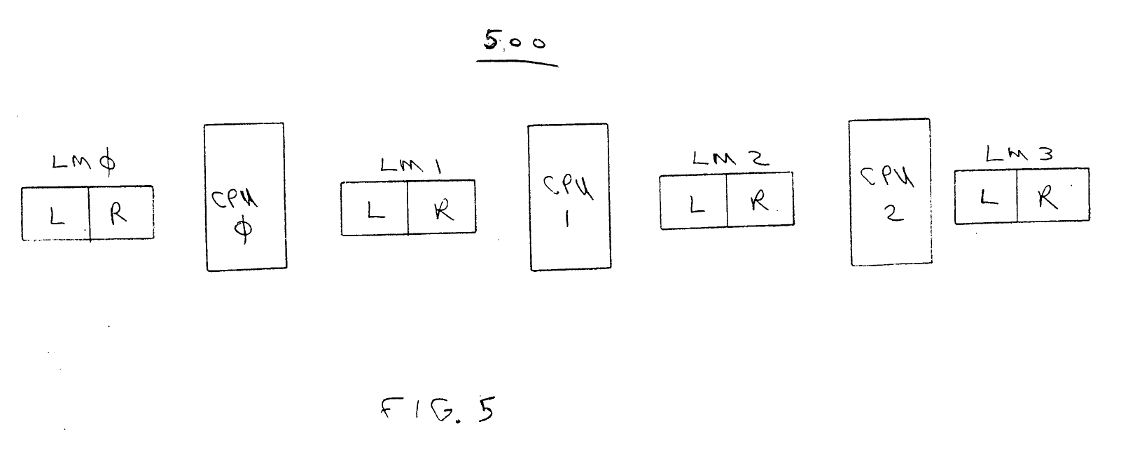

Referring to FIG. 5, there is shown multiprocessing system 500 including CPU 0, CPU 1 and CPU 2 (for example). Four banks of LMs are included, namely LM0, LM1, LM2 and LM3. Each LM is physically interposed between two CPUs and, as shown, is designated as belonging to a left CPU and/or a right CPU. For example, the LM1 bank is split into left (L) LM and right (R) LM, where left LM is to the right of CPU 0 and right LM is to the left of CPU 1. The other LM banks are similarly designated.

In an embodiment of the invention, the compiler determines the number of left/right LM pages (up to 4 pages) needed by each CPU in order to execute a respective task. The OS, responsive to the compiler, searches its main memory (DRAM, for example) for a global table of LM page usage to determine which LM pages are unused. The OS then reserves a contiguous group of CPUs to execute the respective tasks and also reserves LM pages for each of the respective tasks. The OS performs the reservation by writing the task number for the OS process in selected LM pages of the global table. The global table resides in main memory and is managed by the OS.

Since the LM is architecturally visible to the programmer, just like register file 34, each processor may be assigned, by the operating system, pages in the LM to satisfy compiler requirements for executing various tasks. The operating system may allocate different amounts of LM space to each processor to accomplish the execution of an instruction, quickly and efficiently.

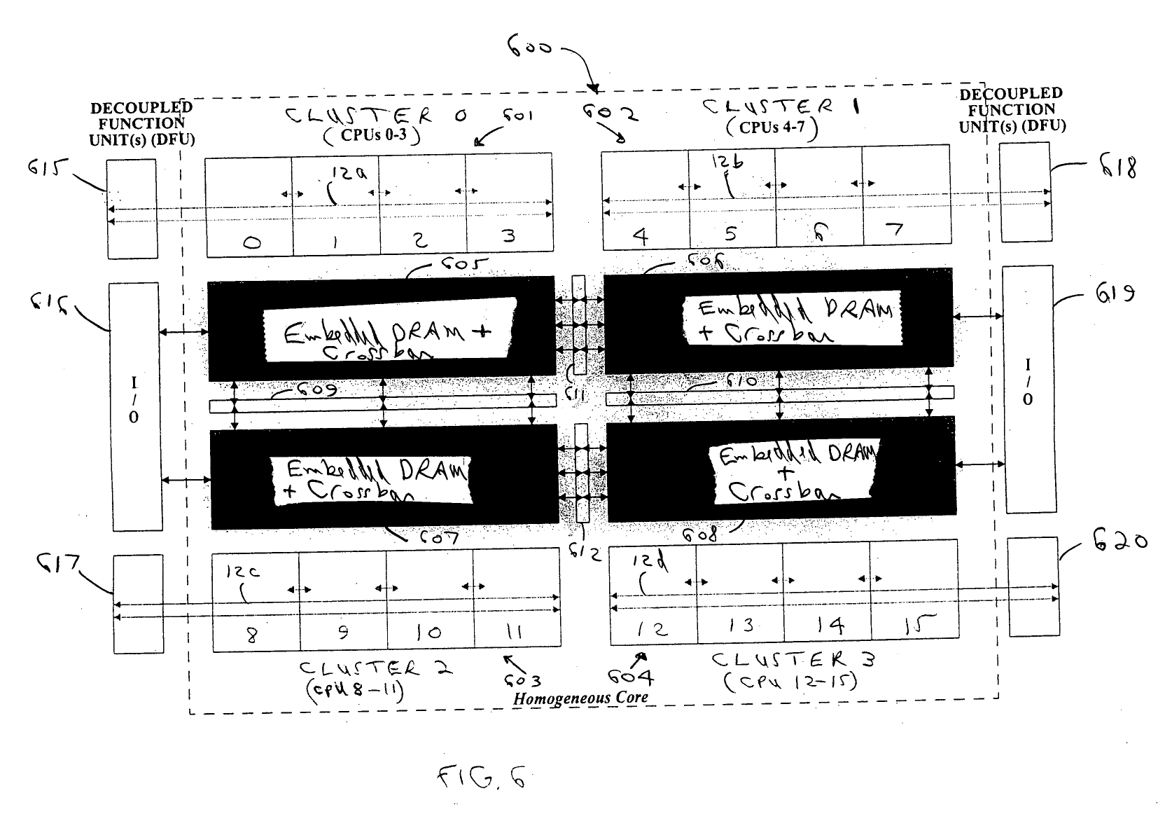

Referring next to FIG. 6, there is shown a homogeneous core of a CMP, generally designated as 600. As shown, CMP 600 includes clusters 0-3, respectively, designated as 601-604. Each cluster includes four CPUs, with each CPU numbered, as shown. CPUs 0-3 are disposed at the top left of the chip, CPUs 4-7 are disposed at the top right of the chip, CPUs 8-11 are disposed at the bottom left of the chip and CPUs 12-15 are disposed at the bottom right of the chip.

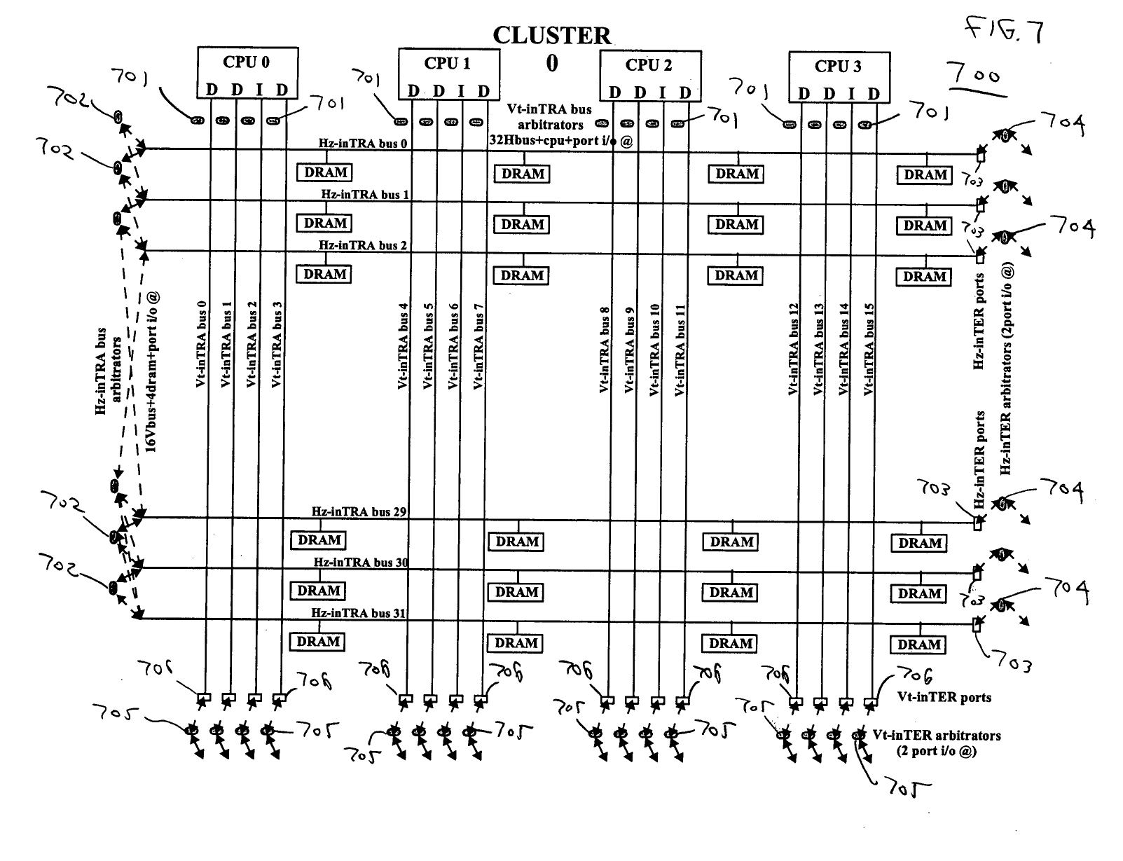

Centrally located and bounded by the four clusters of CPUs, there is shown shared level-two memories 605-608. Each shared level-two memory includes an embedded DRAM and a crossbar that runs above the embedded DRAM. As will be described, any CPU of any cluster may access any page of DRAM in memories 605-608, by way of a plurality of inter-vertical arbitrators 609-610 and inter-horizontal arbitrators 611-612. (A plurality of intra-vertical arbitrators and intra-horizontal arbitrators are also included, as shown in FIG. 7.)

CMP 600 may also access other coprocessors 615, 617, 618 and 620 which are disposed off the chip. Memory may also be expanded off the chip, to the left and right, by way of interface (I/O) 616 and 619. The I/O interface is also capable of connecting multiple copies of CMP 600 into a larger, integrated multi-chip CMP.

It will be appreciated that FIG. 6 illustrates CMP 600 on a macro-level. Each CPU is shown on a micro-level in FIGS. 1-3 (for example). As best shown in FIG. 3, each cluster 300 includes four CPUs, and each CPU includes a dual path processor core (left and right datapaths, as shown in FIGS. 1 and 2). Each CPU, for example CPUn, has half-LM 26a to its left and half-LM 28a to its right. In this manner, each CPU has a local memory (LM 26 and LM 28 in FIG. 1) that is compiler controlled (similar to register files 34a and 34b in FIG. 1). Another view of an LM interposed between one CPU and another CPU may be seen in FIG. 5 (each half-LM is shown as a left (L) LM or a right (R) LM comprising one LM-bank).

It will be appreciated that the LM delivers better performance than a level-one data cache. As such, the present invention has no need for an automatic data cache. Compiler control of data movements through a LM performs better than a conventional cache for media applications.

The LM may function in three different ways. First, it may be a fast-access storage for register spilling/filling for scalar mode processing. Second, it may be used to prefetch “streaming” data (i.e., it is a compiler-controlled data cache), which may “blow out” a normal automatic cache. And, third, the LM may be used as a vector register file. Finally, the LM registers, as shown in FIG. 4, are divided into pages. Pages are physically located between two neighboring CPUs, and may be owned by either one. The pages are not shared; at any given moment each page has one and only one owner. A media-extension instruction transfers page ownership. Shared pages allow vector registers to move data from one CPU to the next.

As previously described, each CPU blends together vector and scalar processing. Conventional scalar SPARC instructions (based on the SPARC Architecture Manual (Version 8), printed 1992 by SPARC International, Inc. and incorporated herein by reference in its entirety) may be mixed with vector instructions, because both instructions run on the same datapaths of an in-order machine. LM-based extensions are easy for a programmer to understand, because they may be divided into two nearly orthogonal programming models, namely two-issue superscalar (2i-SS) and vector. The 2i-SS programming model is an ordinary SPARC implementation. Best case, it consumes two 32-bit wide instructions per clock. It may read and write the local memory with a latency of one clock. But, in the 2i-SS model, that must be done via conventional SPARC load and store instructions, with the LM given an address in high memory. The 2i-SS model may also issue prefetching loads to the LM.

The vector programming model treats the LM as a vector register file. The width of vector data is 64 bits, with the higher 32 bits (big Endian sense) being processed by the left datapath and the lower 32 bits being processed by the right datapath. Vector instructions are 64 bits wide. This large width allows them to include vector count, vector strides, vector mask condition codes and set/use bits, arithmetic type (modulo vs saturated), the width of sub-word parallelism (SWP), and even an immediate constant mode. A vector mask of one bit per sub-word data item is kept in a 64-bit state register. That limits vector length for conditional operations to eight (64-bit) words of 8-bit items, 16 words of 16 bit items or 32 words of 32-bit items. There is no need to preset an external state prior to vector execution. Vector operands for vector instructions may come only from the LM or FIFOs. Core CPU GPRs may only be used for scalar operands.

Returning to FIG. 6, there is shown FIFO busses 12a-12d, respectively, crossing clusters 601-604. Although only two busses are shown, it will be appreciated that there are four 64-bit FIFO busses crossing each cluster of CPUs. As best shown in FIGS. 2 and 3, each CPU is bus master of one FIFO and includes a queue for incoming data from each of the other three CPUs in a cluster. For example, the three incoming FIFO queues 16 (FIG. 2) may, respectively, hold data coming from the other three CPUs in the cluster. Outgoing FIFO queue 14 may hold data outgoing to anyone of the other three CPUs. The destination CPU of the outgoing data may be identified by the tag bits placed in FIFO queue 14. (2 control bits in addition to the 64-bit data word). The FIFOs may be used to chain vector pipelines between CPUs or to combine scalar CPUs into tightly-coupled wider ILP machines. It will be appreciated that the FIFO width of 64 bits is a good match for the vector mode and 2i-SS mode, which consume 64 bits of instruction and operate on 64 bits of data. This further supports vector chaining between CPUs.

Resulting from inter-processor (inter-CPU) communication via the FIFOs, fine grained calculations may be partitioned across multiple processors (CPUs). This leads to a machine that is scalable both in ILP and data level parallelism (DLP). In addition, this FIFO-based communication provides latency tolerance, as a result of its decoupling architecture, as explained below.

Processor/memory speed imbalance has made it vital to deal with memory latency. One strategy is latency reduction via caching. A high cache hit rate effectively eliminates memory latency, albeit at a considerable silicon cost. A different strategy is latency tolerance via decoupling. Decoupled architecture places decoupling FIFOs between instruction/data fetching stages and the execution stages. As long as FIFOs are not emptied by sequential data or control dependencies, latencies shorter than the FIFO depth are invisible to the execution stages. For the multi-processor system of this invention, the strategy of latency tolerance is easier to scale than that of latency reduction.

Today's “post-RISC” superscalar computers are decoupled architecture machines. The register renaming buffer effectively decouples the execution units from the instruction/data-fetch front end, while the reorder buffer decouples the out-of-order execution from the in-order data writeback/instruction retirement back-end. The usefulness and efficiency of FIFOs in the post-RISC architecture is not generally noticed because it is entangled in the general complexity of out-of-order superscalar hardware and because the size of the FIFO is between 50 and 100 instructions, in order to deal with typical off-chip DRAM latencies.

The use of embedded DRAM on the CMP chip dramatically reduces the memory latency. This allows the addition of FIFOs with a length 4 to 8 (for example) to the core CPU, without severe hardware costs.

The invention provides for 32-bit transfers, as well as 64-bit transfers, on the 64-bit FIFO bus. The following is a description of various ways for pairing two 32-bit operands.

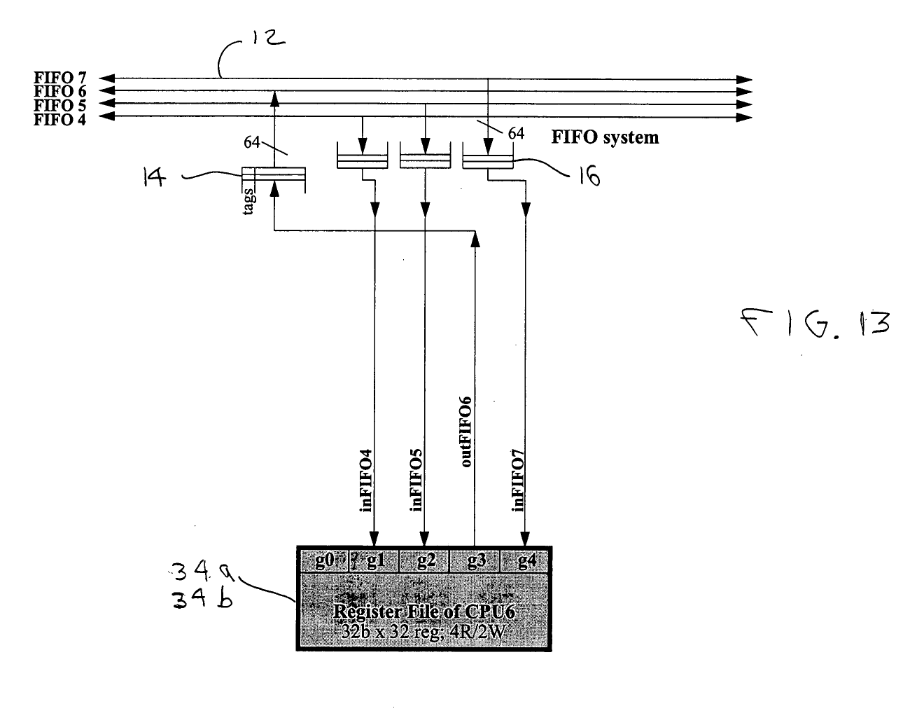

The FIFOs are mapped onto the CPU global general purpose registers (GPRs) in register files 34a and 34b (FIG. 2). As a result, there are no special opcodes required for reading from or writing to a FIFO. Referring to FIG. 13, there is shown, for example, register file 34a, 34b in CPU 6 in cluster 1. As shown, registers g1-g4 are implemented as 64-bit registers. They may also behave as 32-bit registers, if used as operands in 32-bit operations. G1 may be used for inFiFO4 (from CPU 4 in cluster 1) and g2 may be used for inFIFO5 (from CPU 5 in cluster 1). G3 may be used for outFIFO6 (from CPU 6 in cluster 1) and g4 may be used for inFIFO7 (from CPU 7 in cluster 1).

The invention, however, has expanded the FIFO width to 64 bits and, consequently, may have the following options available for transferring 32 bits on the 64-bit FIFO bus.

To ensure correctness regardless of how instructions are paired, a uniform interface is used whether 32 or 64 bits are sent through the FIFOs. No instruction knows whether it is accessing the left half (MSW) or the right half (LSW) of the FIFO on a 32-bit transfer. Therefore, there is just one ISA register per FIFO, not an even-odd pair.

Instructions that produce a 64-bit answer normally write the MSW to an even numbered register and the LSW to the following register. When the destination is a FIFO, however, all 64 bits are written to one FIFO register. Likewise, when reading a 64-bit operand, all 64 bits come from a single FIFO register, instead of an even-odd pair that would be used if it were a normal register.

64-bit transfers are the natural data type for a 64-bit FIFO. No special rules are needed. In case of single 32-bit transfers, there is just one register per FIFO. Therefore, 32-bit results may be written to the same FIFO register that receives 64-bit results, and 32-bit operands may be fetched from the same FIFO register that provides 64-bit operands. When there is one 32-bit write in a cycle, the FIFO may initiate a 32-bit transfer during that cycle rather than wait for 64 bits to accumulate.

Sometimes, two 32-bit writes to the same FIFO register may occur in the same clock. The processor may notice this and route the first (lowest instruction address) result to the MSW of the FIFO and the second result to the LSW of the FIFO. The processor may then initiate a 64-bit FIFO transfer of the two halves. In this manner, even 32-bit data may sometimes use the full bandwidth of the FIFOs.

An ideal situation for paired readout may occur when one of these dual-32-bit transfers arrives at a destination and another pair of instructions tries to read from the same FIFO register at the same time. The destination processor may notice that 64 bits have arrived in the FIFO and that both halves need be used in one clock cycle. The processor may then route the MSW to the first instruction and the LSW to the second instruction. In this ideal situation, 64 bits are written, 64 bits are read, and the FIFO's full bandwidth is used, even though working with 32-bit quantities.

Another situation may occur in which a pair of 32-bit values is written to a FIFO, but in the current clock cycle only one of those values is being read. The processor may then notice that 64 bits have arrived and may route the MSW to the current instruction that wants to read it. The next 32-bit fetch may retrieve the LSW. The FIFO may then have some changeable state bits for each entry, indicating how much of that entry is used. This state may-be manipulated, when reading quantities in a size other than that written. Transparently to the user program, the processor may perform a peek operation to retrieve part of the entry, change the state, and leave the pop for the next access.

A more difficult situation occurs when a single 32-bit value is written to a FIFO but a pair of instructions at the destination try to read two values at a time. In this case, the first instruction may get the value that is there and the second instruction may stall. (It is too late to pair it with the following instruction). The first instruction may not be stalled as it waits for another 32 bits to arrive, as this may create deadlock. The first instruction may be writing to another FIFO which causes another processor to eventually generate input for the second instruction. Therefore, even though the decoder wants to pair the current two instructions, they should be executed sequentially (when 32 bits are present and both instructions want to read 32 bits).

An opposite situation may occur where the source instructions produce 32-bit results and a destination instruction wants to read a 64-bit operand. If the source instructions are paired and produce a packed value that uses the full bandwidth of the FIFO, then the destination instruction may simply read the 64 bits that arrive. If 32 bits at a time are written, however, the destination instruction should be stalled to wait for the full 64 bits. If the instruction that reads the 64 bits is the second instruction in a pair, then the first instruction should be allowed to continue, while the second one is stalled, otherwise deadlock may result. In general, the decode stage does not know the state of the FIFO in the operand read stage, so the instructions may be paired and then split.

Another interesting situation may occur where an instruction wants to read two 32-bit operands from the same FIFO. This may be treated as a 64-bit read, and the MSW may go to the rs1 register and the LSW may go to the rs2 register.

When an instruction wants to read two or more 64-bit operands from the same FIFO, that instruction takes at least two clocks. This type of instruction may not be paired with its predecessor, otherwise deadlock may result.

As a summary of the above description, the following table is provided.

| FIFO | | |
|---|---|---|
| readin | FIFO readout | Comments |
| 64-bit | 64-bit read | Perform in an obvious way to avoid surprises. |
| write | (single value) | |
| 32-bit | 32-bit read | |
| read | (single value) | |
| 32-bit | 32-bit reads | Pack into 64-bit values to use full bus |
| writes | (multiple | bandwidth when possible. Otherwise, treat |
| | values) | each transfer as one of the above cases, as |
| | | appropriate. |
| 64-bit | 32-bit reads | Read pairs when possible, otherwise read half |
| write | | at a time. |
| 32-bit | 64-bit read | Read both halves when 64 bits available. |
| writes | | Otherwise, stall the 64-bit read to wait for |
| | | more data. Do not stall its predecessor or |
| | | deadlock may result. |
| 64-bit | 64-bit reads | Do not pair with predecessor instruction. |
| writes | (multiple | |
| | values) | |

If willing to give up on using the full bus bandwidth for 32-bit transfers, the above may be simplified. In such an embodiment of the invention, a 32-bit write to a FIFO may be zero-filled to 64-bits and transferred as a 64-bit value. A 32-bit read from a FIFO may read the full 64 bits and only use the LSW. This coalesces the above cases. The decoder may prevent the pairing of instructions that both try to read from or both try to write to the same FIFO. Also, the decoder may prevent the next instruction from being paired with its predecessor, if that next instruction reads multiple values from the same FIFO. Deadlock is then avoided. An align instruction would not be needed.

The crossbar plus the embedded DRAM shown as 306 in FIG. 3, will now be described in greater detail. Referring first to FIG. 7, there is shown cluster 0 plus its crossbar to the embedded DRAM, both generally designated as 700. As shown, cluster 0 includes CPU 0-3, with each CPU including four ports (D, D, I, D) to the shared main memory (also shown in FIG. 3, for example, as ports 36a, 38a, 40a, and 42a). Crossbar 306 includes 16 vertical busses, designated Vbus 0-Vbus 15, and 32 horizontal busses, designated Hbus 0-Hbus 31. Vertical busses 0-3 couple the four ports of CPU 0 to any one of the horizontal busses 0-31. Similarly, vertical busses 4-7 couple the four ports of CPU 1 to any one of horizontal busses 0-31. In addition, vertical busses 8-11 couple the four ports of CPU 2 to any one of the horizontal busses 0-31. Finally, vertical busses 12-15 couple the four ports of CPU 3 to any one of the horizontal busses 0-31. Horizontal busses 0-31 connect vertical busses 0-15 to the four DRAM pages connected to each horizontal bus.

As will be explained, each vertical bus and each horizontal bus has associated with it, respectively, a vertical intra-cluster bus arbitrator (each designated by 701) and a horizontal intra-cluster arbitrator (each designated by 702). The vertical intra-cluster arbitrators control the connection of their respective associated vertical bus with any horizontal bus within the same cluster (i.e. intra-busses). Each horizontal intra-cluster bus arbitrator has bus-access-request inputs and bus-grant outputs (not shown) from/to all 16 vertical intra-cluster busses and from each of the four DRAM pages attached to that bus. Each vertical intra-cluster bus arbitrator has bus-access-request inputs and bus-grant outputs from/to all 32 intra-cluster horizontal busses and from the CPU port to which it connects. Once connected to a horizontal bus, the horizontal intra-cluster bus arbitrator controls the connection to any of four possible pages of DRAM (shown hanging from each horizontal bus).

Although not shown, it will be appreciated that clusters 1, 2 and 3 each includes a crossbar coupled to DRAM pages having corresponding vertical intra-cluster arbitrators and corresponding horizontal intra-cluster arbitrators similar to that shown in FIG. 7. Each crossbar (four total) with its vertical and horizontal intra-cluster arbitrators is physically disposed above the embedded DRAM pages belonging to a respective cluster (four total), as shown in FIG. 6.

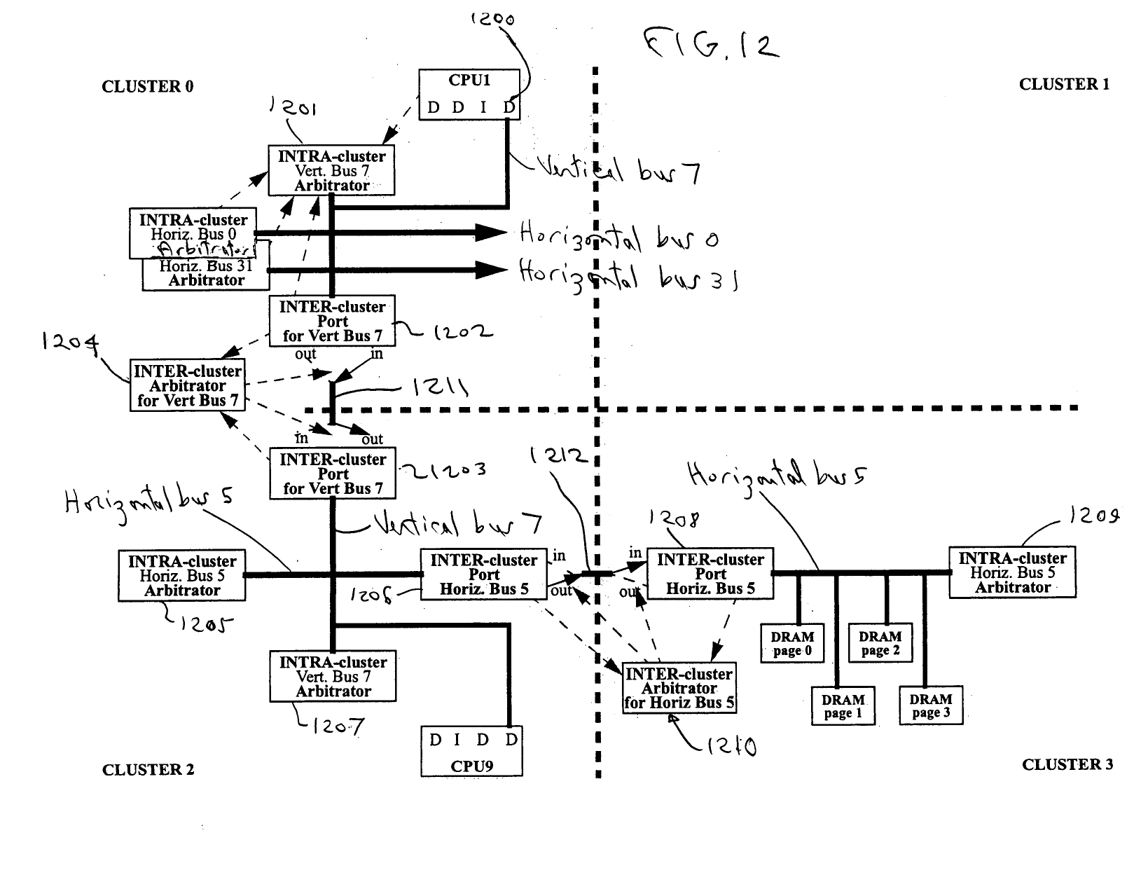

As will also be explained, cluster 0 may communicate with any horizontal bus (Hz intra bus 0-Hz intra bus 31) in cluster 1 to access DRAM pages of cluster 1 by way of 32 inter-cluster horizontal buses. The end of the intra-cluster horizontal bus closest to the neighboring cluster (in this example of FIG. 7, the right end) is equipped with an inter-cluster horizontal port (each designated by 703), which attaches to an inter-cluster bus. Data is written to the inter-cluster port when the intra-cluster bus arbitrator determines that the cluster address of the request is not in the current cluster. Arrival of data into an inter-cluster port triggers a bus-access-request to the associated inter-cluster bus arbitrator (each designated by 704). Access to the inter-cluster bus is granted by an associated inter-cluster horizontal bus arbitrator, shown as 704, on the right side of FIG. 7. Inter-bus arbitrators have only two requestors, the two inter-cluster ports (each designated by 706) on either end of the inter-cluster bus (also refer to FIG. 12). Similarly, cluster 0 may communicate with any vertical bus (Vbus 0-Vbus 15) in cluster 2 to access DRAM pages of cluster 2 by way of 16 vertical inter-cluster buses and their associated arbitrators, shown on the bottom of FIG. 7 (each arbitrator generally designated by 705).

As will be explained, cluster 0 may also communicate with any horizontal bus (Hbus 0-Hbus 31) in cluster 3 to access DRAM pages of cluster 3, by way of a combination of horizontal inter-cluster buses/arbitrators 704 and vertical inter-cluster buses/arbitrators 705. Similarly, any cluster may communicate with any other cluster to access DRAM pages of the other cluster, by way of a combination of horizontal inter-cluster buses/arbitrators and inter vertical inter-cluster buses/arbitrators.

Bus arbitrators are well-known in the art. For the purposes of this invention, all of the standard types of arbitration algorithms (e.g., round-robin, least-recently used, etc.) are suitable for both the intra-bus and the inter-bus arbitrators. While one type or another type may give higher performance, any arbitrator that does not lock out low-priority requestors (and thereby cause deadlocks) may be utilized by the invention. The algorithm used by the arbitrator is conventional and is not described. However, the control inputs to the arbitrators form a part of this invention, and will be described later.

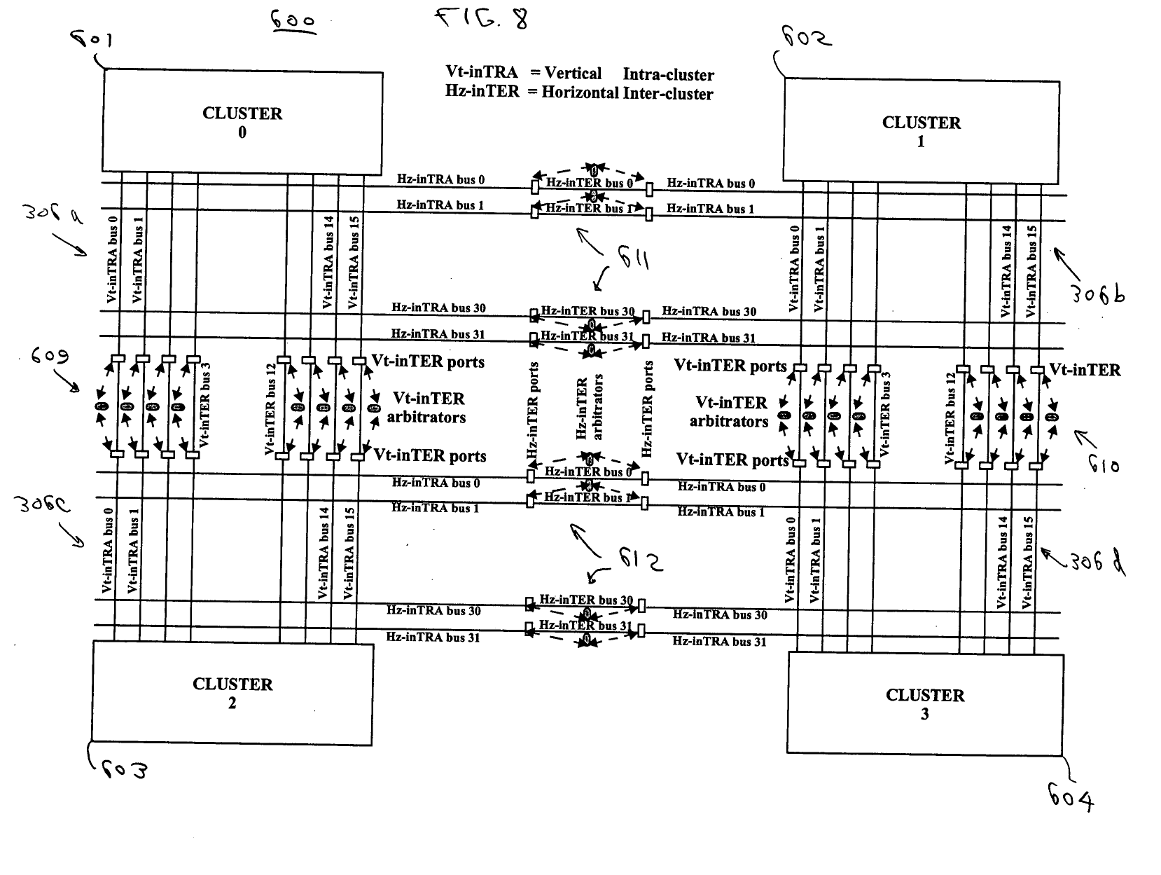

Referring next to FIG. 8, there is shown CMP 600 having cluster 0 (601), cluster 1 (602), cluster 2 (603) and cluster 3 (604). Four sets of embedded DRAM plus crossbar, designated 306a -306d, are shown coupled, respectively, to clusters 0-3 (DRAM, horizontal intra-cluster and vertical intra-cluster arbitrators are not shown). Horizontal inter-cluster ports and arbitrators 611 are disposed between DRAM plus crossbar 306a and DRAM plus crossbar 306b. Horizontal inter-cluster ports and arbitrators 612 are disposed between DRAM plus crossbar 306c and DRAM plus crossbar 306d. In a similar manner, vertical inter-cluster ports and arbitrators 609 are disposed between DRAM plus crossbar 306a and DRAM plus crossbar 306c. Finally, Vertical inter-cluster ports and arbitrators 610 are disposed between DRAM plus crossbar 306c and DRAM plus crossbar 306d.

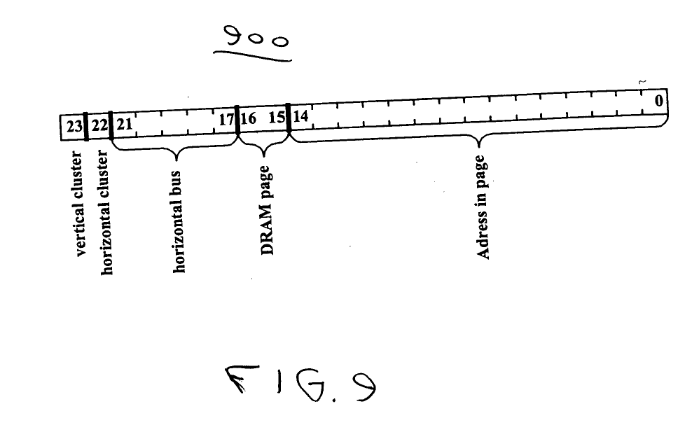

Referring next to FIG. 9, there is shown an embodiment of the bitfields for memory addressing in CMP 600. The CMP contains 16 MBytes (2²⁴ bytes) of DRAM. As shown, the memory addressing may be by way of a 24-bit address, generally designated as 900. As an example, bits 22 and 23 may be used to identify the cluster (0-3).

The vertical cluster bit (bit 23) may be used by the vertical intra-cluster arbitrators to decide whether this address is in the same vertical group of clusters or the other vertical group. The horizontal cluster bit (bit 22) may be used by the horizontal intra-cluster arbitrators to decide whether this address is in the same horizontal group of clusters or the other horizontal group. Bits 21-17 may select one of 32 horizontal busses inside a cluster. (Effectively, bit 23+bits 21-17 define 64 horizontal busses). Bits 16-15 may select one of 4 pages on a bus. Bits 14-0 may select an address inside one 32 kByte page.

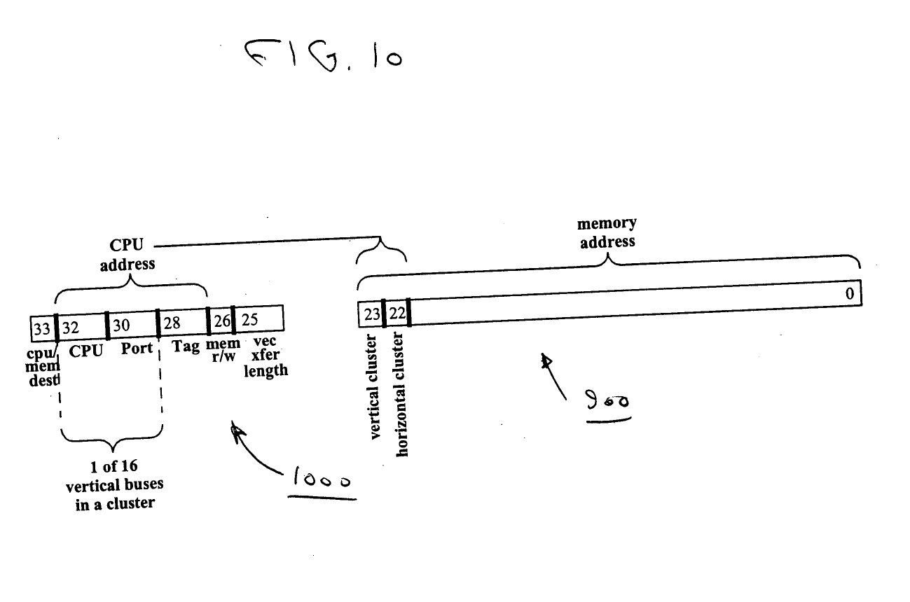

It will be appreciated that each bus in a crossbar is a “split-transaction” bus, in which an arbitrator may request control of the bus only when the arbitrator has data to be transferred on the bus. In a “split-transaction” bus all transactions are one-way, but some transactions may have a return address. Split transaction buses reduce to zero the number of cycles during which a bus is granted but no data is moved on that bus. An estimate is that split transactions improve bus capacity by as much as 300%. The invention uses split transactions to avoid deadlock for memory activities that must cross cluster boundaries. As a result, FIG. 10 shows an embodiment in which the addressing of main memory includes memory address field 900 (as shown in FIG. 9) and additional bits, generally designated by 1000, which are necessary for the split-transaction. As shown, bit 33 may select whether the destination of a transaction is a CPU or a main memory. If the destination is a memory, bit 26 may determine whether the transaction is a memory read or memory write. If the transaction is a memory read, the CPU address (bits 32-27) may be used as a return address tag. This tag may be retained by the memory controller and later used to generate an address for another transaction, which may return the read value to the requesting CPU/port/tag slot.

It will be appreciated that, as shown in FIG. 10, to reach a specific port of a given CPU, data must use the appropriate vertical bus. This may be accomplished with bits 23-22 plus bits 32-29.

Completing the description of FIG. 10, two bits (bit 25-24) may be used to specify the number of 64-bit transfers requested by a vector load/store operation. The vector transfer length may be 1, 2, 4 or 8 64-bit transfers.

In general, a transaction, which originates at a CPU, first travels down/up a vertical bus (as shown in FIG. 8), until it arrives at the horizontal bus having the DRAM destination. Next, the transaction travels across the horizontal bus, until it arrives at the appropriate DRAM page. A transaction which originates in DRAM, first travels across a horizontal bus, until it arrives at the vertical bus, on which the destination port of a CPU lies. Next, the transaction travels up/down the vertical bus, until it arrives at the destination.

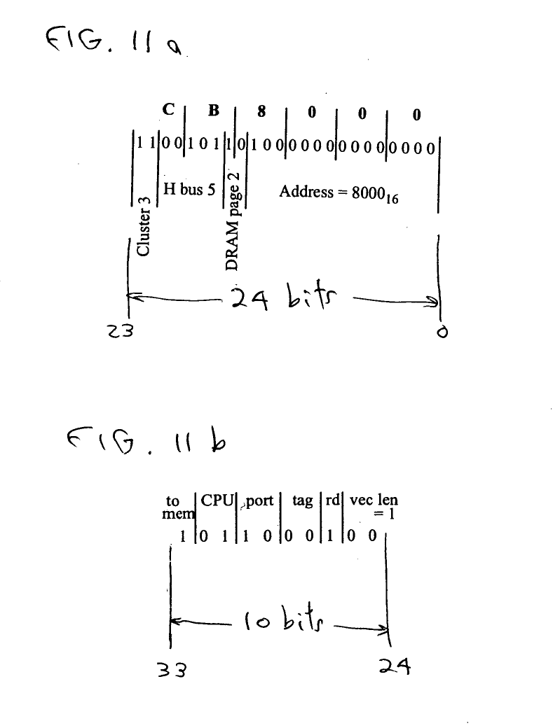

As an example of using the crossbar with the bit fields shown in FIGS. 9 and 10, reference is now made to FIGS. 11a and 11b. In the illustrated example, CPU 1 of cluster 0 is requesting a read operation from its right LM data port (vertical bus 7 in FIG. 7) to DRAM address 12,720,000₁₀ or CB8000₁₆. This address may be translated, as shown in FIG. 11a, as located at DRAM page 2 (10) attached to horizontal bus 5 (00101) in cluster 3 (11). The remaining bits (24-33) providing control information for the CPU to memory read operation are shown in FIG. 11b, and correspond to bits 24-33, shown in FIG. 10, where tag=00 is arbitrarily assigned to this memory read operation.

Because the example provided is a read operation, two transactions occur. The first transaction originates in CPU 1, and the second transaction originates in DRAM. These transactions are now described below with reference to FIG. 12.

In operation, the first transaction from the right LM data port (designated 1200) of CPU 1 proceeds as follows:
1. The right LM data port of CPU 1 (1200) requests control of Vertical Bus 7 from Intra-Vbus 7 arbitrator 1201.
2. Gaining that bus, data port 1200 places the 34-bit control information on the bus. The bus hardware reads the V cluster bit (bit 23) and recognizes that the destination cluster is different from the current cluster. Accordingly, it delivers the control information to Cluster 0, Vertical Inter-cluster port for Vbus 7, designated as 1202.
3. The arrival of data in Inter-cluster port 1202 triggers the Inter-cluster V bus 7 arbitrator, designated as 1204. When Inter-cluster bus 1211 is granted, it transfers the control information to Cluster 2, Inter-cluster port for V bus 7, designated as 1203.
4. Next, V bus 7 Inter-cluster port 1203 requests cluster 2's vertical bus 7. When the bus is granted, the bus hardware recognizes that the destination address is on Horizontal bus 5. Accordingly, Vertical bus 7 arbitrator 1207 requests control of H bus 5 from Intra-cluster H bus arbitrator 1205.
5. When Horizontal bus 5 is granted, its hardware determines that the destination is in the other cluster (3). As a result, it delivers the control information to Inter-cluster port 1206.
6. Arrival of data in Inter-cluster port 1206 triggers Inter-cluster H bus 5 arbitrator 1210. When Inter-cluster bus 1212 is granted by arbitrator 1210, the control information is delivered to Inter-cluster port 1208.
7. Inter-cluster port 1208 requests control of cluster 3's horizontal bus 5. When it is granted control by Intra-cluster arbitrator 1209, the hardware determines that the destination is DRAM page 2. As a result, the control information is written into DRAM page 2.
8. The CPU address (bits 33-22) are saved by the DRAM hardware and used to generate the destination of the return transaction.

The second transaction, as the return transaction of DRAM to CPU, will now be described. The destination of this transaction is the return address of CPU 1, port 3 (1200) on vertical bus 7 in cluster 0. It will be appreciated that if a transaction's destination is a CPU, the memory address bits (bits 21-0) may be set to zero. In operation, the following sequence occurs:
1. DRAM page 2 of Horizontal bus 5 in cluster 3 requests control of Horizontal bus 5.
2. When the bus is granted by Intra-cluster arbitrator 1209, the hardware reads the horizontal-cluster bit (bit 22) and determines the destination vertical bus (CPU 1, port 3, vertical bus 7) is in the other cluster (2). As a result, it delivers the control information and a data word (64 bits) to Inter-cluster port 1208.
3. Arrival of the data triggers Inter-cluster arbitrator 1210.
4. When inter-cluster bus 1212 is granted by arbitrator 1210, control information and the data word are moved to cluster 2's Inter-cluster port 1206.
5. Arrival of data in port 1206 causes the port to read the data and determine that it needs to control vertical bus 7. The port requests control of vertical bus 7 from Intra-cluster arbitrator 1207.
6. When the vertical bus is granted, the vertical bus hardware reads the vertical cluster bit and determines that the destination lies in the other cluster (0). As a result, it delivers the control information and the data word to cluster 2's vertical bus 7 Inter-cluster port 1203.
7. Arrival of data triggers Inter-cluster arbitrator 1204.
8. When Inter-cluster bus 1211 is granted by arbitrator 1204, the control information and the data word are moved to cluster 1's Inter-cluster port 1202.
9. Arrival of data triggers the port to request control of vertical bus 7 from cluster 1's Intra-cluster arbitrator 1201.
10. When the bus is granted, the bus hardware reads the destination and delivers the data word to the CPU port attached to that bus. The data word is placed in a tag slot which may be named in the tag field (bits 28-27) of the control information.

It will be appreciated that the routing of split-transactions (described above) across multiple clusters is handled automatically by bus and arbitrator hardware. No intervention or pre-planning is required by the compiler or the operating system. All memory locations are logically equivalent, even if their associated access time may be different. In other words, the invention uses a non-uniform memory access (NUMA) architecture.

It will be understood that planning which places data in memory locations close to the CPU that is using the data is likely to reduce the number of inter-cluster transactions and improve performance. Although such planning is desirable, it is not necessary for operation of the invention.

The following applications are being filed on the same day as this application (each having the same inventors):

VECTOR INSTRUCTIONS COMPOSED FROM SCALAR INSTRUCTIONS; TABLE LOOKUP INSTRUCTION FOR PROCESSORS USING TABLES IN LOCAL MEMORY; VIRTUAL DOUBLE WIDTH ACCUMULATORS FOR VECTOR PROCESSING; CPU DATAPATHS AND LOCAL MEMORY THAT EXECUTES EITHER VECTOR OR SUPERSCALAR INSTRUCTIONS.

The disclosures in these applications are incorporated herein by reference in their entirety.

Although the invention is illustrated and described herein with reference to specific embodiments, the invention is not intended to be limited to the details shown. Rather, various modifications may be made in the details within the scope and range of equivalents of the claims and without departing from the invention.

1. A chip multiprocessor (CMP) comprising
a plurality of processors disposed on a peripheral region of a chip, each processor including
(a) a dual datapath for executing instructions,
(b) a compiler controlled register file (RF), coupled to the dual datapath, for holding operands of an instruction, and
(c) a compiler controlled local memory (LM), a portion of the LM disposed to a left of the dual datapath and another portion of the LM disposed to a right of the dual datapath, for holding operands of an instruction,
a shared main memory disposed at a central region of the chip,
a crossbar system for coupling the shared main memory to each of the plurality of processors, and
a first-in-first-out (FIFO) system for transferring operands of an instruction among multiple processors of the plurality of processors.

2. The CMP of claim 1 wherein
the shared main memory includes embedded DRAM disposed in the central region of the chip, and
the crossbar system is disposed above the embedded DRAM.

3. The CMP of claim 1 wherein
each processor includes at least one data port for accessing the shared main memory,
the shared main memory includes a plurality of pages of embedded DRAM, and
the crossbar system includes a plurality of horizontal and vertical busses, each horizontal bus coupled to at least one page of embedded DRAM and each vertical bus coupled to a different port of the plurality of processors.

4. The CMP of claim 3 wherein
each of the horizontal and vertical busses is configured as a split-transaction bus, in which data on each bus flows in only one direction at a time.

5. The CMP of claim 1 wherein
the compiler controlled RF is coupled to a data port for accessing the shared main memory,
an instruction cache is coupled to an instruction port for accessing the shared main memory,
the portion of the LM disposed to the left of the dual datapath and the other portion of the LM disposed to the right of the dual datapath are each coupled to a data port for accessing the shared main memory, and
the data port of the RF, the instruction port of the instruction cache, and the data ports of the portions of the LM are separate ports configured to separately access the shared main memory.

6. The CMP of claim 1 wherein
the FIFO system includes registers mapped to registers located in the RF.

7. The CMP of claim 1 wherein
the FIFO system includes a plurality of registers, each register configured to store data by a respective processor for destination to another processor.

8. The CMP of claim 1 wherein
the portion of the LM disposed to the left of the datapath and the other portion of the LM disposed to the right of the datapath each includes a level-one memory of a predetermined size, and
the predetermined size is a variable size predetermined by the compiler.

9. The CMP of claim 1 wherein the LM and the RF are level-one memories and the shared main memory is a level-two memory, and
the CMP is free-of an automatic data cache.

10. The CMP of claim 1 wherein
the shared main memory includes an embedded DRAM and
a double buffered sense amplifier for overlapping a next fetch with a current read operation.

11. A chip multiprocessor (CMP) comprising
first, second, third and fourth clusters of processors disposed on a peripheral region of a chip, each of the clusters of processors disposed at a different quadrant of the peripheral region of the chip, and each including a plurality of processors for executing instructions,
first, second, third and fourth clusters of embedded DRAM disposed in a central region of the chip, each of the clusters of embedded DRAM disposed at a different quadrant of the central region of the chip, and
first, second, third and fourth crossbars, respectively, disposed above the clusters of embedded DRAM for coupling a respective cluster of processors to a respective cluster of embedded DRAM,
wherein a memory load/store instruction is executed by at least one processor in the clusters of processors by accessing at least one of the first, second, third and fourth clusters of embedded DRAM by way of at least one of the first, second, third and fourth crossbars.

12. The CMP of claim 11 wherein
each of the plurality of processors of each of the clusters of processors includes a plurality of data ports, each configured to access the at least one of the clusters of embedded DRAM.

13. The CMP of claim 11 wherein
each of the crossbars includes horizontal and vertical busses,
the vertical busses of the first, second, third and fourth crossbars, respectively, coupled to ports of the processors of the first, second, third and fourth clusters of processors, and
the horizontal busses of the first, second, third and fourth crossbars, respectively, coupled to pages of the first, second, third and fourth clusters of embedded DRAM.

14. The CMP of claim 13 wherein
inter-cluster horizontal arbitrators are coupled between inter-cluster ports attached to the horizontal busses of the first and second crossbars, and between inter-cluster ports attached to the horizontal busses of the third and fourth crossbars, and
inter-cluster vertical arbitrators are coupled between inter-cluster ports attached to the vertical busses of the first and third crossbars, and between inter-cluster ports attached to the vertical busses of the second and fourth crossbars.

15. The CMP of claim 11 wherein
a FIFO system is configured to couple processors in a cluster of processors for transferring operands of an instruction between the processors in the cluster.

16. The CMP of claim 15 wherein
the FIFO system includes a plurality of input FIFOs and a single output FIFO assigned to a processor in the cluster,
the input FIFOs configured to store data transferred from other processors in the cluster to the processor in the cluster, and
the output FIFO configured to store data transferred from the processor to the other processors in the cluster.

17. The CMP of claim 11 wherein
each of the processors in each cluster includes a compiler controlled local memory (LM), a portion of the LM disposed to a left of each processor and another portion of the LM disposed to a right of each processor for holding operands of an instruction.

18. The CMP of claim 17 wherein
the LM includes a predetermined number of pages of memory, and
the number of pages of the LM assigned to neighboring CPUs is a task-dependent variable determined by the compiler.

19. The CMP of claim 17 wherein
the LM includes at least one port configured to access at least one of the clusters of embedded DRAM.

20. The CMP of claim 19 wherein
the LM is configured to receive streaming media data, stored in the at least one cluster of embedded DRAM, via at least one port.
